(19) United States
(12) Patent Application Publication
(10) Pub. No.: US 2024/0386490 A1
(43) Pub. Date: Nov. 21, 2024

(54) AUTOMATED RISK IMPACT IDENTIFICATION AND ASSESSMENT

(71) Applicant: Ultima Insights, LLC, Ann Arbor, MI (US)

(72) Inventors: Mohammed N. Nasir, Watsonville, CA (US); Adithya Sairamachandran, Troy, MI (US)

(21) Appl. No.: 18/244,422

(22) Filed: Sep. 11, 2023

Related U.S. Application Data
(60) Provisional application No. 63/467,710, filed on May 19, 2023.

(51) Int. Cl. G06Q 40/03

(52) U.S. Cl. CPC G06Q 40/03

(57) ABSTRACT

An automated large language model (LLM) based risk summarization system and method, wherein the system includes: a latent information extraction subsystem configured to extract latent information of an entity through querying an LLM for latent knowledge related to the entity; a document information extraction subsystem configured to obtain document information related to the entity from one or more documents; a search query generator subsystem configured to formulate one or more search queries based on the latent information and the document information; a content finder subsystem configured to execute the one or more search queries to obtain search results having content indicator data; and a content summarizer subsystem configured to use the LLM or another LLM to create a summary of content associated with the content indicator data.

### TECHNICAL FIELD

This disclosure relates to automated process of identifying and validating qualitative information on financial entities and drawing qualitative conclusions based on this information.

### BACKGROUND

Individuals who are interested in various news events and their effects on various companies find it difficult to utilize search engines, such as Google™ to gather relevant information. Searching for a particular company directly yields several results that subjectively talk about stock price or other quantitative factors that are repetitive and/or lacking in detail as to how an event connects to the company's bottom line. Additionally, there is no insight with search engines as to any ancillary risks faced by each company. As a result, the burden is on the individual to know beforehand the events to look for. Given the need to act on a particular news event within a limited period of time, in order to (for example) take advantage of potential trading opportunities, this issue is usually intractable when tracking more than a few companies simultaneously.

### SUMMARY

In accordance with an aspect of the disclosure, there is provided an automated large language model (LLM) based risk summarization system. The automated LLM based risk summarization system includes: a risk identification subsystem configured to extract information of an entity and to identify one or more risks faced by the entity based on the extracted information; a risk validation subsystem configured to generate augmented risk data based on analyzing the one or more identified risks with trusted source document information obtained from one or more trusted source documents; a search query generator subsystem configured to formulate one or more search queries based on the one or more identified risks and the augmented risk data; a content finder subsystem configured to execute the one or more search queries to obtain search results having content indicator data; and a content summarizer subsystem configured to use the LLM or another LLM to generate summary data that provides a summary of content associated with the content indicator data.

The system may further include any of the following features or any technically-feasible combination of two or more of the following features:
the risk validation module uses a pre-trained version of Bidirectional and AutoRegressive Transformer (BART) to categorize chunks of text from trusted source documents into appropriate risk categories;
the risk validation module uses an LLM to validate, augment, and summarize risk descriptions;
the search query generator creates a graph of query templates based on predefined templates for each risk category;
the news finder generates tensors with the embeddings for all the headlines found for a given financial entity, and a tensor with the embeddings for the elaborated risk description tied to the risk associated with a given article;
the relevancy determination module uses an LLM to determine the top three most impactful headlines to the financial entity based on the risks faced by the entity;
the article summarizer uses an LLM to create a summary around how each of the articles impacts the financial entity based on the risks faced by the entity;
the system further comprises a mechanism for synthesizing company-level summaries or insights based on either the company's long-term history or immediate events influencing the near-term;
the news finder further applies a Headline Relevancy Model Transformer Neural Network to filter out spam articles and score the relevance of each article;
the Headline Relevancy Model Transformer Neural Network boosts the score if the headline includes the company name directly or specific keywords for a given risk category;
the news finder filters out articles that are duplicated, score less than the minimum relevancy score, or are from blacklisted websites/publishers, or are published before a certain number of days;
the content finder subsystem is configured to select the one or more search queries for execution based on a predefined threshold for query relevancy score generated based on relevancy of a given search query to the augmented risk data;
the content finder subsystem is configured to generate content relevancy scores for resulting content based on each's relevance to the one or more identified risks;
further comprising a relevancy determination subsystem configured to select content to obtain based on the content relevancy scores, to obtain the content, and to store the content in a vector database; and/or
the summary data indicates, for a given article describing one or more events, impacts that are forecasted for the entity based on the identified risks and the one or more events.

In accordance with another aspect of the disclosure, there is provided an automated large language model (LLM) information extraction and summarization system, including: a latent information extraction subsystem configured to extract latent information of an entity through querying an LLM for latent knowledge related to the entity; a document information extraction subsystem configured to obtain document information related to the entity from one or more documents; a search query generator subsystem configured to determine one or more search queries based on the latent information and the document information; a content finder subsystem configured to execute the one or more search queries to obtain search results having content indicator data; and a content summarizer subsystem configured to use the LLM or another LLM to create a summary of content associated with the content indicator data.

The system may further include any of the following features or any technically-feasible combination of two or more of the following features:
the latent information and the document information pertain to one or more risks associated with the entity, and wherein the summary of the content is generated based on the one or more risks;
the content indicator data of the search results includes headlines of one or more articles, and wherein the content associated with the content indicator data includes a body for each of the one or more articles; and/or
the content finder subsystem is configured to generate relevancy scores for the content indicator data relative to a relevancy target, and wherein the relevancy scores are used to select content associated with the content indicator data.

In accordance with another aspect of the disclosure, there is provided a method of retrieving and summarizing content based on risks for an entity. The method includes: extracting latent information of an entity through querying an LLM for latent knowledge related to the entity; obtaining document information related to the entity from one or more documents; determining one or more search queries based on the latent information and the document information; executing the one or more search queries to obtain search results having content indicator data; and using the LLM or another LLM to create a summary of content associated with the content indicator data.

### BRIEF DESCRIPTION OF THE DRAWINGS

FIG. 1 is a block diagram illustrating an information extraction and summarization system that is used to perform automated identification and summarization of content relevant to a company or other entity, according to one embodiment;

FIG. 2 is a block diagram illustrating an automated risk impact summarization system that implements components of the information extraction and summarization system of FIG. 1, according to one embodiment;

FIG. 3 is a block diagram illustrating the automated risk impact summarization system as well as a processing flow that is carried out by the automated risk impact summarization system;

FIG. 4 is a block diagram illustrating a risk identification subsystem that is a part of the automated risk impact summarization system of FIG. 3, according to one embodiment;

FIG. 5 is a block diagram illustrating a risk validation subsystem that is a part of the automated risk impact summarization system of FIG. 3, according to one embodiment;

FIG. 6 is a block diagram illustrating a search query generator subsystem that is a part of the automated risk impact summarization system of FIG. 3, according to one embodiment;

FIG. 7 is a block diagram illustrating a news finder generator subsystem that is a part of the automated risk impact summarization system of FIG. 3, according to one embodiment;

FIG. 8 is a block diagram illustrating a relevancy determination subsystem that is a part of the automated risk impact summarization system of FIG. 3, according to one embodiment;

FIG. 9 is a block diagram illustrating an article summarizer subsystem that is a part of the automated risk impact summarization system of FIG. 3, according to one embodiment;

FIG. 10 is a flowchart illustrating a method of retrieving and summarizing content based on risks for an entity, according to one embodiment; and

FIG. 11 is a shown an exemplary screenshot of a webpage having content and content indicator data, according to one embodiment.

### DETAILED DESCRIPTION

There is provided an automated large language model (LLM) information extraction and summarization system and method, which enables automated identification and summarization of content relevant to a company or other entity, such as for purposes of providing information on how current events (as described in news articles) affect the entity. According to embodiments, the automated LLM information extraction and summarization system is configured to perform a method of retrieving and summarizing content based on risks for an entity. The automated LLM information extraction and summarization system may be referred to as an automated large language model (LLM) based risk summarization system when used for risk summarization. According to one embodiment, the method includes: extracting latent information of an entity through querying an LLM for latent knowledge related to the entity; obtaining document information related to the entity from one or more documents (e.g., trusted source documents, such as 10-K filings or earning's call transcripts); determining one or more search queries based on the latent information and the document information; executing the one or more search queries to obtain search results having content indicator data; and generating content summary data through use of the LLM or another LLM, where the content summary data includes a summary of content associated with the content indicator data. In embodiments, the content summary data is risk impact summarization data, which is data that includes a summary of how events indicated in the content affect risks faced by the entity.

Accordingly, in embodiments, there is a system and method that automates the process of identifying and analyzing the risks faced by a company (or other entity) using a variety of trusted sources, such as, for example, regulatory filings, earning's call transcripts, and news articles. One or more risks for the entity may be identified through analyzing the trusted source documents and then the risks are used to generate a set of search queries to be executed for the entity. The search queries may then be run or executed using a search engine to obtain a set of results, and these results often include titles of webpages, which may be headlines of a news article presented on the webpage; this search result information about a webpage is content indicator data as this information is used to indicate content of a resource (e.g., webpage). The headline (or other content indicator data) of each search result (which may correspond to a news article, for example) is then run through a relevancy model that quantitatively scores (e.g., where each score is from one (1) to five (5)) how relevant the headline is to the description of the identified risk(s). According to embodiments, search queries may be scored based on a aggregate metric determined based on scores of a plurality of search results; for example, the relevancy scores of the search results are averaged to obtain an average relevancy score or a search result relevancy score. The search result relevancy score may be stored and used to determine a frequency with which the search query is selected to be executed. As such, high-quality queries are run more frequently, at least according to embodiments.

In embodiments, the system and method enable automated risk monitoring and impact assessment that is responsive to new content (e.g., new publications) pushed out over the internet, for example, such as news articles and financial-related filings and information. The automated LLM information extraction and summarization system and method discussed above may thus be adapted to risk identification, monitoring, and reporting on impacts of the identified risks. Accordingly, this system is referred to an automated risk impact summarization system, which is an example of the automated LLM information extraction and summarization system.

According to embodiments, the most relevant articles for a given company are stored in a vector store for use and recall with some type of interactive mechanism, such as a chatbot. Alternatively, this information may be used to synthesize company-level summaries or insights based on either the company's long-term history or immediate events influencing the near-term.

The automated risk impact summarization system is used to identifying, validating, and analyzing qualitative information related to financial entities based on their associated risks. Also, according to embodiments, the automated risk impact summarization system is used to perform the method of retrieving and summarizing content based on risks for an entity, which may include identifying, validating, and analyzing qualitative information related to financial entities based on their associated risks. The automated risk impact summarization system implements an automated risk impact summarization pipeline that is used to perform the method.

According to embodiments, the system, method, and framework are implemented through use of one or more, generally multiple, instances of large language models (LLMs), each of which may be configured for a different function or purpose. More particularly, the architecture is designed to harness current LLMs, such as a GPT-4 model or a GPT-3 model (e.g., such as text-davinci-003 by OpenAI™). Generative Pre-trained Transformer (GPT) technology (including its most recent rendition, GPT-4) is an autoregressive LLM technology that uses deep learning to produce human-like text, more particularly through using transformer technology set forth initially in Vaswani, Ashish, et al. “Attention is all you need.” Advances in neural information processing systems 30 (2017). It will be appreciated that, according to embodiments, LLMs built on technologies other than the transformer technology may be used. According to embodiments, the system, method, and framework are implemented through use of one or more, generally multiple, instances of large language models (LLMs), each of which is specifically tailored for performing particular type of operations.

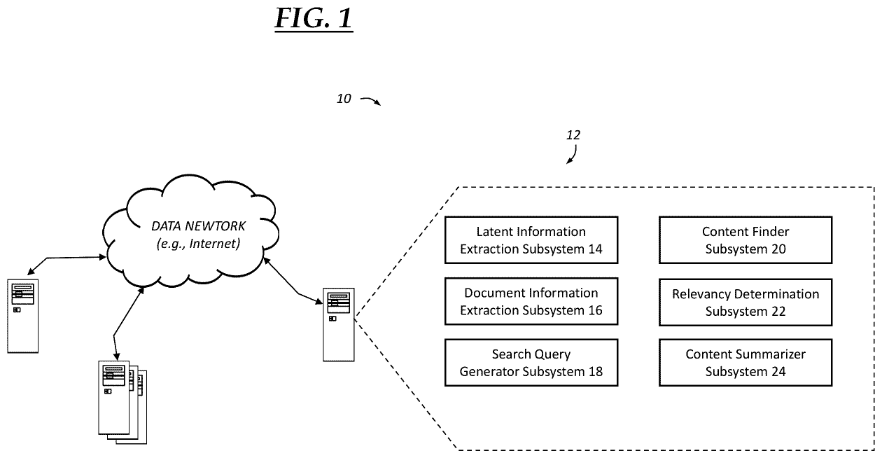

With reference to FIG. 1, there is shown an automated large language model (LLM) information extraction and summarization system 10, including an automated large language model (LLM) information extraction and summarization pipeline 12, which includes a plurality of subsystems, each of which is a computer subsystem and is implemented using at least one processor and memory storing computer instructions that, when executed by the at least processor, cause the subsystem's associated functionality to be performed. The automated LLM information extraction and summarization pipeline 12 includes a latent information extraction subsystem 14, a document information extraction subsystem 16, a search query generator subsystem 18, a content finder subsystem 20, a relevancy determination subsystem 22, and a content summarizer subsystem 24, at least according to the illustrated embodiment.

The latent information extraction subsystem 14 is configured to extract information of an entity through querying an LLM for latent knowledge related to the entity. The latent information extraction subsystem includes a LLM latent knowledge querying module, which is used to query an LLM for latent knowledge about a given topic, such as a company or other entity, in order to generate LLM latent knowledge data. As discussed below, this latent data may be used to formulate a list of risks faced by the company.

The document information extraction subsystem 16 is configured to extract information from trusted source documents (“trusted source document data”), such as information related to the entity (e.g., relevant to risks faced by a company). In embodiments, the document information extraction subsystem 16 is configured to use a LLM, such as a pre-trained version of BART (Bidirectional and Auto-Regressive Transformers), to process text from trusted source documents, such as to extract certain information, for example, information pertaining to predefined risk categories.

The search query generator subsystem 18 is configured to determine one or more search queries based on the latent knowledge related to the entity and the trusted source document information (or other document information). For example, the search queries may be formulated or otherwise determined based on identified risks and attributes of the entity that were extracted from the trusted source document(s).

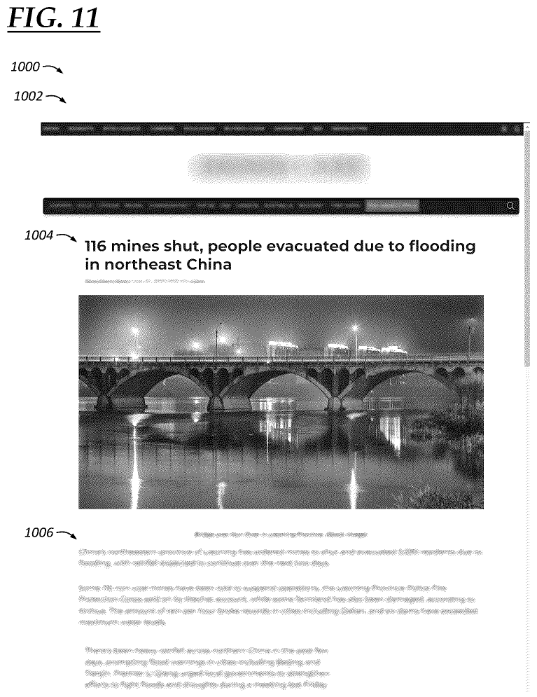

The content finder subsystem 20 is configured to execute the one or more search queries to obtain search results having content indicator data (e.g., headline of an article, a title of a document) and to generate relevancy scores for the content indicator data relative to a relevancy target. The content indicator data is data that serves to describe or characterize substance of content associated with the content indicator data. For example, a resource, such as a webpage, often includes a title, headline, tagline, abstract, or other concise textual statements of content made available or located at the resource; common examples include a title of a document or a headline of a news article. For example, with reference to FIG. 11, there is shown a screenshot of a webpage 1000 having content 1002, including a headline constituting content indicator data 1004 and body text content 1006. In embodiments, such as where hypertext markup language (HTML) resources are fetched via the search queries, identifying content indicator data may be done programmatically, manually, or some combination thereof. For example, to identify the title of a news article on an HTML page, one typically examines common HTML tags like <h1>, which frequently encases article titles, or the <title> tag within the <head> section, though this may include additional webpage information. For programmatic extraction across multiple webpages, libraries like Beautiful Soup™ or Puppeteer™ may be beneficial, especially because consistent structures in websites from the same source simplify the extraction logic, in some instances.

The relevancy determination subsystem 22 is configured to select content based on the relevancy scores and to store the selected content in a vector database. The relevancy determination subsystem 22 is further configured to fetch the selected contents based on the relevancy scores, which may be generated based on the content indicator data associated with the content (as discussed above), at least in embodiments.

The content summarizer subsystem 24 is configured to use a Large Language Model (LLM) to generate content summary data, where the content summary data includes a summary of content associated with the content indicator data. In embodiments, the summary data indicates, for a given article describing one or more events, impacts that are forecasted for the entity based on the identified risks and the one or more events. Using prompting, the content summary data may be directed to pay attention to certain risks or factors affecting an entity, such as weather in certain locations.

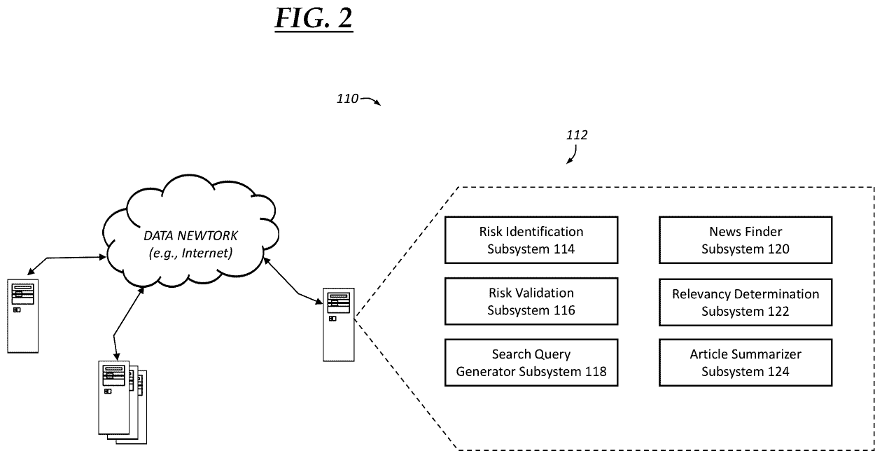

With reference to FIG. 2, there is shown an automated risk impact summarization system 110 that is an example of the LLM information extraction and summarization system 10 and that implements an automated risk impact summarization pipeline 112, which includes a plurality of subsystems, each of which is a computer subsystem and is implemented using at least one processor and memory storing computer instructions that, when executed by the at least processor, cause the subsystem's associated functionality to be performed. The automated risk impact summarization pipeline 112 includes a risk identification subsystem 114, a risk validation subsystem 116, a search query generator subsystem 118, a news finder subsystem 120, a relevancy determination subsystem 122, and an article summarizer subsystem 124, at least according to the illustrated embodiment.

The risk identification subsystem 114 is an example of the latent information extraction subsystem 14 and is configured to extract attributes, such as key or important attributes, of a financial entity and to formulate a list of risks faced by the entity along with brief descriptions. In embodiments, the risk identification subsystem 114 is configured to utilize a knowledge store, such as a database of structured information or a Large Language Model (LLM) to obtain information about the financial entity.

The risk validation subsystem 116 is an example of the document information extraction subsystem 16 and is configured to analyze trusted source documents in order to validate and augment the identified risks. In embodiments, the risk validation subsystem 116 is configured to use a pre-trained version of BART (Bidirectional and Auto-Regressive Transformers) to categorize chunks of text from trusted source documents into appropriate risk categories. Also, in embodiments, the risk validation subsystem 116 is configured to use an LLM to validate, augment, and summarize risk descriptions.

The search query generator subsystem 118 is an example of the search query generator subsystem 18 and is configured to determine search queries based on the identified risks and document information, which may indicate important attributes or information, of the entity. In embodiments, the search query generator subsystem 118 is configured to create a graph of query templates based on predefined templates for each risk category.

The news finder subsystem 120 is an example of the content finder subsystem 20 and is configured to select search queries for execution based on a predefined threshold for average query relevancy score and to generate scores for resulting articles based on each's relevance to the identified risks. In embodiments, the news finder subsystem 120 is configured to use a Search Engine Results Page (SERP) API to run search queries on a search engine, such as Google™ Search, in batches. In some embodiments, the news finder subsystem 120 is configured to apply a Headline Relevancy Model Transformer Neural Network to filter out spam articles and score the relevance of each article. At least in some embodiments, the Headline Relevancy Model Transformer Neural Network boosts the score if the headline includes the company name directly or specific keywords for a given risk category. In embodiments, the news finder subsystem 120 is configured to filter out articles that are duplicated, score less than the minimum relevancy score, or are from blacklisted websites/publishers, or are published before a certain number of days.

The relevancy determination subsystem 122 corresponds to the relevancy determination subsystem 22 and is configured to select articles based on the scores and to store the articles in a vector database. In embodiments, the relevancy determination subsystem 122 is configured to use an LLM to determine the top N (e.g., three) most impactful headlines to the financial entity based on the risks faced by the entity.

The article summarizer subsystem 124 is an example of the content summarizer subsystem 24 and is configured to use a LLM to create a summary of how each of the selected articles impacts the financial entity based on the identified risks. In embodiments, the article summarizer subsystem 124 is configured to use an LLM to create a summary around how each of the articles impacts the financial entity based on the risks faced by the entity. In embodiments, the article summarizer subsystem 124 includes one or more LLM computers, which is a computer that is configured to execute an LLM, such as GPT-4, for example.

According to other embodiments, the pipeline 12 and/or the pipeline 112 further include a user interaction subsystem that implements an interactive mechanism, such as a chatbot, for retrieving and presenting the most relevant articles for a given financial entity from the vector database.

According to other embodiments, the pipeline 12 and/or the pipeline 112 further include a synthesis subsystem that implements a mechanism for synthesizing company-level summaries or insights based on either the company's long-term history or immediate events influencing the near-term.

The term “subsystem” is used herein to define a particular portion of a larger system where the portion is directed toward a particular processing task. Accordingly, it will be appreciated that the term “subsystem” is not intended and is not to be read in a limiting manner; rather, each of the subsystems may be implemented using one or more of the same and/or one or more different computers.

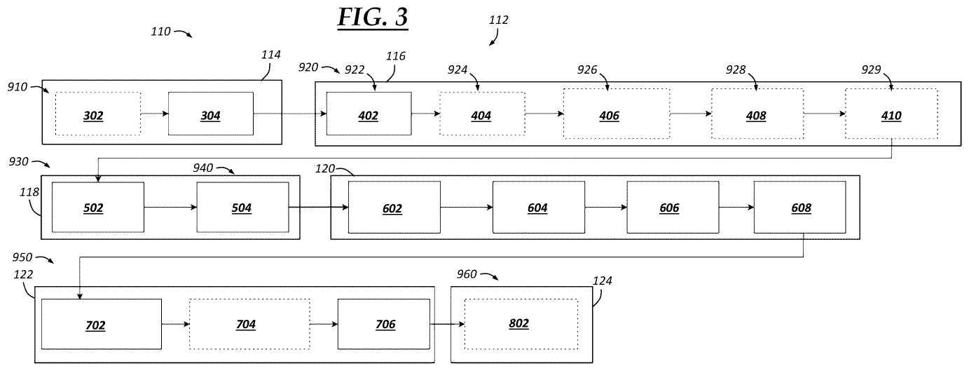

With reference to FIG. 3, there is shown an embodiment of an automated risk impact summarization system 110 that implements an automated risk impact summarization pipeline 112, including a risk identification subsystem 114, a risk validation subsystem 116, a search query generator subsystem 118 shown together with a news finder subsystem 120, and a relevancy determination subsystem 122 shown together with an content summarizer subsystem 124. Like reference numerals denote like components and, in particular, reference numerals differing by 1100 generally refer to like components. For example, the automated risk impact summarization system 110 corresponds to the automated risk impact summarization system 110 and the discussion of the automated risk impact summarization system 110 is hereby incorporated and attributed to the automated risk impact summarization system 110; likewise, the discussion of each like component 112-24 is hereby incorporated and attributed to is corresponding component 112-124 to the extent such discussion is not inconsistent with the express discussion below of such corresponding component 110-124.

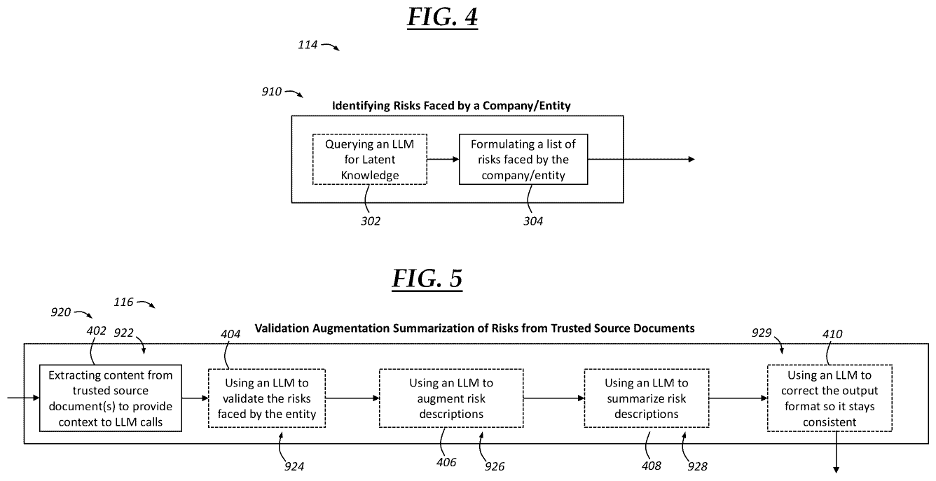

With reference to FIG. 4, there is shown the risk identification subsystem 114, including an LLM latent knowledge querying module 302 that is configured to query an LLM for latent knowledge about a given topic, such as a company or other financial entity, in order to generate LLM latent knowledge data, which is then used to formulate a list of risks faced by the company, as shown at initial risk identification module 304. Many large language models are trained on a large corpus of available documents, such as those accessible over the internet. Such documents may include information about a particular company or entity, such as information about what products or services a company provides, where the company operates, where the company sources its goods from, etc. For example, GPT-4 is a LLM that is configured to generate human-like text outputs through generating predictions based on input. The mapping of input to output (or predictions) are conditioned through training the LLM and this is generally performed organizations with substantial resources, such as OpenAI™, Google™, Facebook™ AI, and Microsoft™. The latent knowledge of the LLM is only as up to date as the training data is that it is trained on and so the latent knowledge available from the LLM is constrained to a time period prior to the training or release of the model. However, techniques for updating LLMs may be used to better ensure that the LLM stays up to date.

The initial risk identification module 304 then uses the LLM latent knowledge data to identify an initial set of risks faced by the entity. The initial risk identification module 304 may use an LLM that takes, as input, the latent knowledge data and then is directed (prompted) to output a list of risks faced by the company or entity, and this information is referred to as initial risk data. The initial risk data may include indications or extents of risk for each of a plurality of predefined risk categories, or may obtained more of an unstructured output, such as a paragraph outlining, discussing, and/or describing the risks. The initial risk data is then output by the risk identification subsystem 114, and its output may be used by the risk validation subsystem 116, as discussed below.

With reference to FIG. 5, there is shown the risk validation subsystem 116, including a trusted source extraction module 402, a risk validation module 404, a risk augmentation module 406, a risk summarization module 408, and an output format enforcement module 410. The risk validation subsystem 116 uses one or more trusted source documents to validate and augment risk information obtained by the risk identification subsystem 114. As used herein, a trusted source document is a document that is a document that originates from a trusted or reliable source, such as documents submitted to governmental authorities. For example, a 10-K is an example of a trusted source document as it is a report that is submitted to the Securities and Exchange Commission (SEC) each year by a publicly-traded company. Other such examples include an 8-K, a 120-F, and earnings call transcripts, which are transcripts of quarterly calls with investors detailing the past quarter's financial performance.

The trusted source extraction module 402 is used to extract content from a trusted source document. In embodiments, the trusted source extraction module 402 is configured to use a LLM, such as a pre-trained version of BART (Bidirectional and Auto-Regressive Transformers), to categorize chunks of text from trusted source documents into risk categories, such as one or more of a set of predefined risk categories. For example, a paragraph in a 10-K may include information about risks of the company as well as a description of how the company faces said risk whereas other sections may contain numerical financial data, or information about pending legal proceedings, for example. The content that is extracted may be represented as extracted trusted source document data, and this data may be generated by passing portions of the trusted source document into a LLM that then generates extracted trusted source document data; for example, the LLM may be fine-tuned or instructed via prompts to pay particular attention to risks. In embodiments, one or more predefined risks, such as those determined by the risk identification subsystem 114, may be passed as a part of an input (part of a prompt) into the LLM so that the LLM, in producing its output, pays more attention to those one or more inputted predefined risks. In embodiments, the initial risk data is used to construct an input, such as through including the entire initial risk data or portions thereof in the input, which is passed to the LLM used by the trusted source extraction module 402 and used for generating the extracted trusted source document data. The extracted trusted source document data may be stored in memory, such as a vector database. The extracted trusted source document data may be combined with the initial risk data or may incorporate those risks into its processing flow so that the extracted trusted source document data includes or otherwise captures the initial risk data (or portions thereof). The extracted trusted source document data and the initial risk data are each referred to as extracted risk data generally; accordingly, the extracted risk data includes the extracted trusted source document data and/or the initial risk data.

The risk validation module 404 validates the risks faced by a company or entity and, in the present embodiment, achieves this through use of an LLM that takes, as input, extracted risk data and determines whether the inputted information comports with the latent features imparted into the model. For example, latent information of the LLM is used by the LLM during its processing (specifically, its forward pass/inference) to determine whether the extracted risk data is consistent (or not inconsistent) with other information known to the LLM. The term “validate” and its other various forms (e.g., validating, validated, validation), as used herein, refer to producing information representing whether an input comports and is not inconsistent with a general corpus of knowledge or information; further, the term “valid” and its other various forms, refer to validation of data and, in this regard, valid data is data that comports and is not inconsistent with a general corpus of knowledge or information. For example, a steel manufacturer may be identified as having Reputational Risk where bad press may negatively affect the stock price. However, upon processing of the 10-K, the system finds that Reputational Risk is minimal to this company due to the overall lack of press coverage. Additional example: a software company may have been incorrectly identified as being exposed to Supply Chain Risk. Upon processing of the 10-K, this association is removed by the system. The risk validation module 404 produces risk validation data, which is data that indicates whether the extracted risk data is valid and/or a confidence of the validity of the extracted risk data. The risk validation may be used to prune or otherwise modify the extracted risk data, such as dropping risks that are determined not to be valid; this modified extracted risk data is referred as validated extracted risk data.

The risk augmentation module 406 generates augmented risk data that is used to augment other risk data, such as the validated extracted risk data generated as a result of the validation performed by the risk validation module 404. The augmented risk data is used to fill in holes or otherwise augment the validated extracted risk data passed in as input into the risk augmentation module 406. In some embodiments, each risk in the list of risks (which may be a part of the validated extracted risk data) has a description associated with it, and this list of risk is augmented with competition and financial risk information if such information is not already included in the list. Also, based on information in the validated extracted risk data, additional, relevant information in terms of a financial risk perspective may be generated as augmented risk data; for example, two assertions made in the validated extracted risk data may be associated (via the LLM's latent knowledge) with the occurrence of another risk not included in the validated extracted risk data and/or an extent or a risk included in the validated extracted risk data. This information may be used as augmented risk data that may be combined with the validated extracted risk data to produced “augmented validated extracted risk data”.

The risk summarization module 408 is used to generate data representing summarizations of risks, such as those included in the augmented validated extracted risk data. In embodiments, the risk summarization module 408 uses an LLM to summarize the risk descriptions into a brief, elaborated, and extended description so as to generate three risk descriptions for each risk. For example, a forward pass may be used for each risk of a plurality of risks included in the augmented validated extracted risk data so that a lot of contextual information about the risk may be inputted into the LLM, as LLM's have a maximum number of tokens that may be used as input, such as a 12048 or 4096 token limit. Thus, in embodiments, a summary for each risk is generated using a separate forward pass of the LLM; however, in embodiments, multiple risk summaries may be generated in a single pass, such as where the contextual information for both may fit into the input. The risk summaries are represented by risk summary data that is output by the risk summarization module 408.

The output format enforcement module 410 is used to correct the output format so that output of the risk validation subsystem 116 is consistent in terms of format. In embodiments, the output format enforcement module 410 uses an LLM with custom prompts and/or that is finetuned in order to enforce output format consistency. In other embodiments, in addition to or in lieu of the LLM, rule-based processing may be performed so as to format the output appropriately. The output format enforcement module 410 is used to transform the risk summary data into risk summary data that is formatted and that may be referred to as formatted risk summary data. The risk validation subsystem 116 outputs the formatted risk summary data, which may be stored in memory and/or passed to another subsystem, such as the search query generator subsystem 118.

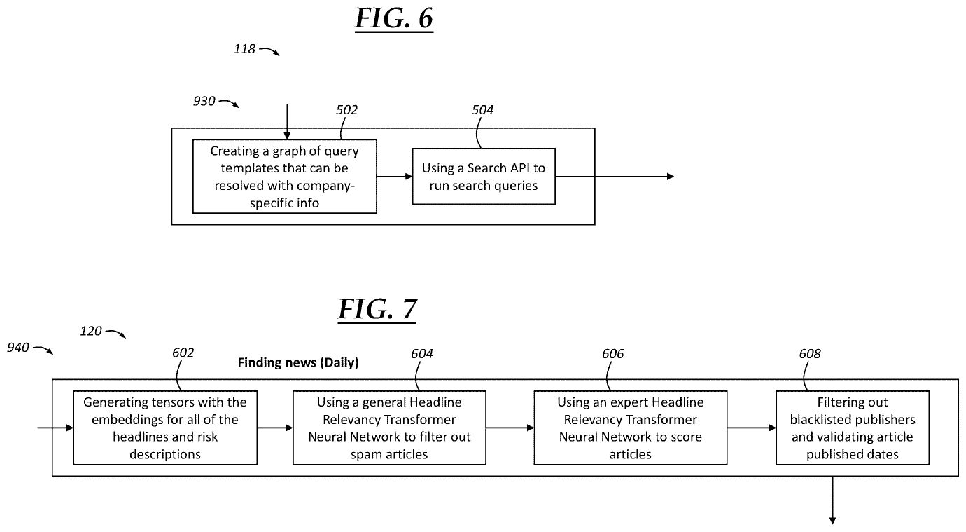

With reference to FIG. 6, there is shown the search query generator subsystem 118, which is used to generate search queries to be executed in order to retrieve information, such as updated news information, and then executing those search queries to obtain search result data. As shown in the embodiment of FIG. 6, the search query generator subsystem 118 includes a search query generator module 502 and a search query executor module 504. The search query generator module 502 is used to generate search queries to be executed in order to retrieve information a risk, an entity, and/or both. In embodiments, the search query generator subsystem 118 creates a set or a graph of query templates based on predefined templates for each risk category. The predefined templates are each a template input object (e.g., a primitive string type object) that is then filled out or otherwise modified based on the company risk data. Each of the query templates is then resolvable to a runnable search query for the company. The list of search queries to be run is stored in memory. In embodiments, the generation of the query or queries may be done by another instance of an LLM, such as one specifically tailored for this purpose.

The search query executor module 504 is used to execute the search queries generated by the search query generator module 502. The search query executor module 504 executes a search query by initiating a network call according to the search query, and where the search query specifies a network address, such as a uniform resource locater (URL), and/or includes a payload or parameter values, such as query parameters. A response to the network call is then received and this includes data representing a database query result or a resource, such as an HTML page having content, such as a news article, and this data may be referred to generally as search query result data. The search query result data (or simply the “search result data”) may be stored in memory, such as a cloud database or other data store, and may be used for further processing, such as by the news finder subsystem 120.

With reference to FIG. 7, the news finder subsystem 120 includes a search result embedder module 602, a search result filter module 604, a search result relevancy scorer module 606, and a search result validation module 608.

The search result embedder module 602 is used to generate embeddings that are then used to perform one or more operations such as filtering (see the search result filter module 604) and relevancy scoring (see the search result relevancy scorer module 606). The embeddings may be LLM embeddings that are generated using an LLM. These embeddings may be represented as tensors, which may be stored in memory. In the depicted embodiment of FIG. 7, embeddings (represented by tensors) are generated for headlines and risk descriptions, such as through using risk data generated by the risk identification subsystem 114 and/or the risk validation subsystem 116. In embodiments, the news finder subsystem 120 generates tensors with the embeddings for the headlines found for the company (or entity) and generates a tensor with the embeddings for the elaborated risk description tied to the risk associated with a given search result, which may be a news article, for example. These tensors for the headlines are referred to as result embedding data and those tensors (or “embedding tensors”) for the risk descriptions is referred to as risk description embedding data. In embodiments, spam articles may be filtered out by the search result filter module 604 using a headline relevancy model transformer neural network (general model), and a second pass of the headline relevancy model transformer neural network by the search result relevancy scorer module 606 is used to score each article from, for example, 1-5, based on how relevant the article is. In this second pass, an expert learner (or expert model) is used, which (in the present embodiment) is another instance of the headline relevancy model network (using the same architecture of the first model) that is fine-tuned specifically on supervised training examples for the sector a company is in (e.g. technology, basic materials, communication services, etc.). This enables the model to give a more realistic score for articles because there is more specificity in the kinds of examples it is trained on. In regard to the general model and the expert model, the “general” model (for module 604) is trained on data from the entire universe, whereas the “expert” models (for module 606) are experts on a particular sector. The general model is mainly intended to remove articles that are completely irrelevant to finance in general, such as product result pages from online stores, or explicit adult content that somehow ended up in the results. The expert models then filter the remaining results to obtain the most relevant and impactful news to the company within each sector. In general, the relevancy model is custom, comprising of a number of transformer encoder layers and a number of fully connected layers, with the embedding of the headline and risk description as the inputs, and a single numerical output indicating the relevancy score, at least according to embodiments.

The search result filter module 604 is used to filter out spam articles, such as programmatically-generated articles that are formed from templates that are automatically filled in with data. Other such undesirable results may be removed or filtered out as well. In embodiments, including the depicted embodiment of FIG. 7, a general relevancy model, which may be implemented using a transformer neural network, is used to perform such filtering.

The search result relevancy scorer module 606 is used to score articles, other documents, or other collections of data in terms of relevancy to a target context. The target context for the search result relevancy score may be or include portions of the risk data generated by the risk identification subsystem 114 and/or the risk validation subsystem 116 and/or other data pertaining to the company or entity. The score or other output indicating an extent of relevancy generated by the search result relevancy scorer module 606 is referred to as search result relevancy score data. In embodiments, a Relevancy Model Transformer Neural Network is used to generate the search result relevancy score data, and this neural network is more generally referred to here as a risk relevancy model. The resulting scores of the articles are referred to as content relevancy scores and these content relevancy scores may be boosted if the headline includes the company name directly or specific keywords for a given risk category.

The search result validation module 608 is used to validate content, such as news articles, and, in doing so, filtering out articles (or other content) based on publication dates of the content, such as those older than a certain number of months or years, as well as filtering out blacklisted publishers. In embodiments, articles that are duplicated, score less than a predetermined relevancy score, or that are blacklisted websites/publishers may be filtered out. Article metadata, such as the publication date, may be fetched and articles may be filtered based on date, such as filtering out articles that are X or more days old, for example. The list of articles (as filtered) may be stored in memory.

Although the embodiment of FIG. 7 describes the operation of the modules 602-608 as being carried out in a particular order, it will be appreciated by those skilled in the art that the modules and their respective operations may be configured and carried out in a different manner, such as where blacklisted publishers are filtered out prior to generating the tensors at the search result embedder module 602.

The filtered search results and/or corresponding score information (generated by the search result relevancy scorer module 606) may be stored in memory and/or passed to another module for processing, such as the relevancy determination subsystem 122.

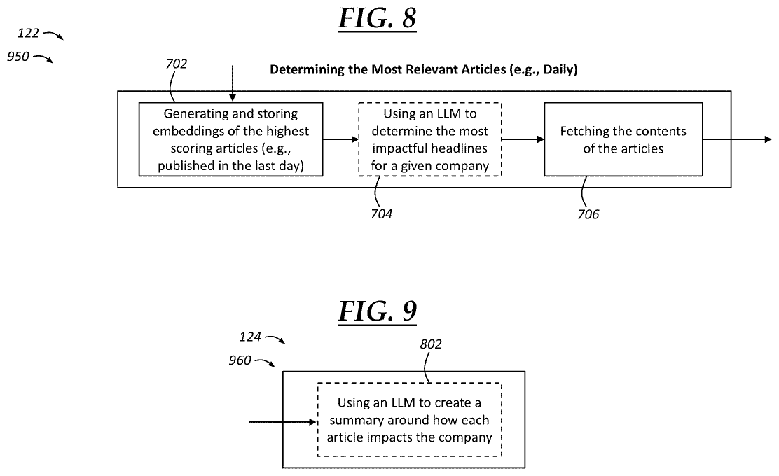

With reference to FIG. 8, the relevancy determination subsystem 122 includes an embeddings caching module 702, an impact assessment module 704, and a content fetching module 706. The embeddings caching module 702 is used to store embedding data in a database, such as in a vector database. In embodiments, the embedding data is determined by selecting one or more articles based on relevancy scores generated by the relevancy determination subsystem 122 through scoring article data (e.g., headline text); for example, the top N highest scoring articles are selected based on content relevancy score that have been published in the last day, where N is an integer such as 120 that may be predetermined; in another embodiment, the articles may be selected using different or additional criteria, such as semantic similarity between the risk description and the headline of the article. The semantic similarity is determined by a vector distance between the embedding tensors as defined in the previous paragraph. The embeddings of the headlines may be stored into a data store, such as a vector database.

The impact assessment module 704 is used to assess the impact of risks faced by the company or entity in connection with article data, such as the headline text. For example, the risk descriptions for each risk faced by the company may be queried, and the top M number of impactful headlines to the company based on the risks are determined through use of an LLM. Here, M is an integer such as 3 that may be predetermined.

The content fetching module 706 is used to fetch contents of articles, such as the body text of one of the articles deemed to be the most impactful. In embodiments, for example, a hypertext transfer protocol (HTTP) call is made to a URL (e.g., a webpage hosting a news article) to obtain web browser-interpretable content, such as hypertext markup language (HTML); the HTML may then be parsed to extract information relevant to an article, such as the body of a news article. In other embodiments, contents may be fetched from network calls using a defined application programming interface (API) that serves up the contents in response to queries properly submitted pursuant to the API. In some embodiments, the top M articles from the impact assessment module 704 are selected for having their contents fetched.

With reference to FIG. 9, the content summarizer subsystem 124 includes a content summarization module 802 that is used to generate summaries of articles or other content. In embodiments where the content summarizer subsystem 124 is used to generate summaries of articles, the subsystem 124 may be referred to also as an article summarizer subsystem. The content summarization module 802 uses an LLM summarization pipeline to summarize content, such as a body of a news article, in order to generate concise, rich interpretations of the content that are shorter in length (in terms of tokens/characters). The content summaries (e.g., article summaries) generated by the content summarizer module 802 are then stored in memory and/or sent to another module or subsystem for processing.

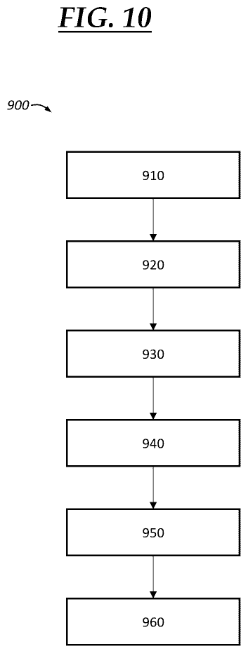

More than merely showing an exemplary system architecture, FIGS. 2-8 depict an end-to-end automated process of identifying, validating, and analyzing qualitative information related to financial entities based on their associated risks and is an exemplary implementation of the more general method 900, which is discussed below in connection with FIG. 10.

With reference now to FIG. 10, and with continued reference to FIGS. 2-8, the method 900 is shown as beginning with step 910, wherein attributes of a company are extracted and a list of risks faced by the entity is determined. Furthermore, in embodiments, brief descriptions of the risks faced by the entity are determined as well. As shown in FIGS. 2 and 3, this step 910 includes, for example, querying an LLM for latent knowledge thereby extracting or obtaining latent knowledge about a company or other entity, and this latent information is then used to formulate the list of risks faced by the company. In embodiments, this may include querying a LLM with a large store of knowledge, such as GPT-4, and then obtaining the results as the latent information. This latent information is then evaluated or inspected in order to identify one or more risks, such as selecting one or more of a set of predefined risks, for the company. As shown in FIG. 3, this step is carried out by the risk identification subsystem 114 in the present embodiment.

In embodiments, attributes of the entity, such as important aspects of the entity, are extracted from the latent knowledge of the LLM and stored in memory. Such attributes may include the location of the company, where it operates, the company's competitors, etc. In some embodiments, each risk in the list of risks has a description associated with it, and this list of risk is augmented with competition and financial risk information if such information is not already included in the list. In embodiments, the description is a brief description (defined in terms that specify a maximum token/word length); however, in other embodiments, the description is an elaborated description (defined as the brief description of the risk, written colloquially with additional details and examples without numerical facts and statistics) or is an extended description (defined as the elaborated description, but written informatively and included numerical statistics, examples, and historical context). The elaborated and extended descriptions each add on additional details, facts, statistics, and examples. In some embodiments, a plurality of descriptions are generated for each risk, such as a brief description, an elaborated description, and an extended description. The method 900 continues to step 920.

In step 920, trusted source documents are analyzed in order to validate and augment the identified risks. In embodiments, such as the embodiment shown in FIG. 3, this step 920 is performed by the risk validation subsystem 116 and includes extracting content from trusted source document data, which is data of one or more trusted source documents, as shown at 922; then, at 924, the extracted content is used by an LLM to validate the risks faced by the entity; then, at 926, an LLM is used to augment risk descriptions and, at 928, an LLM is used to summarize the risk descriptions; and, lastly, at 929, an LLM is used to correct the output format so it stays consistent. As mentioned above, according to embodiments, the system, method, and framework are implemented through use of one or more, generally multiple, instances of large language models (LLMs), each of which is specifically tailored for performing particular type of operations. Here, the LLM mentioned for each of these operations may be the same or different instances and/or models, as the particular implementation details may vary depending on the particular application in which the system and/or method is used.

In embodiments, the trusted source documents include a 10-K filing for the company, and certain data is extracted therefrom, such as from the 1A and 7A risk sections of the 10-K filing. In embodiments, the extracted content from the trusted source document(s) is then split into chunks and each chunk is assigned to a risk category that is most appropriate based on the content of the chunk and through use of a pretrained version of Bidirectional and AutoRegressive Transformer (BART), for example. Irrelevant chunks that are not tied to one of the risks faced by the company may be filtered out. The content of the 10-K filing may be used to augment the company risk descriptions or other company risk data. In sub-step 928, the LLM is used to summarize the risk descriptions into a brief, elaborated, and extended description so as to generate three risk descriptions for each risk. The method 900 continues to step 930.

In step 930, search queries are formulated based on the identified risks and document information, which may indicate attributes of the entity. In embodiments, such as the embodiment shown in FIGS. 3 and 6, this step 930 is performed by the search query generator subsystem 118 and includes creating a set or a graph of query templates based on predefined templates for each risk category. The predefined templates are each a template input object (e.g., a primitive string type object) that is then filled out or otherwise modified based on the company risk data. Each of the query templates is then resolvable to a runnable search query for the company. The list of search queries to be run is stored in memory. In embodiments, the generation of the query or queries may be done by another instance of an LLM, specifically tailored for this purpose. The method 900 continues to step 940.

In step 940, a search query execution and scoring process is performed where search queries are selected for execution, the selected search queries are executed to obtain a set of search results, and the search results are scored in terms of relevancy to the identified risks. In embodiments, the search queries are selected based on a predefined threshold for average query relevancy score. In embodiments, the search query execution and scoring process is carried out by the news finder subsystem 120 and, in some embodiments, the news finder subsystem 120 uses a Search Engine Results Page (SERP) API to run search queries on a search engine, such as Google™ Search, in batches. According to embodiments, once the search results are returned, the news finder subsystem 120 generates tensors with the embeddings for the headlines (or other content indicator data) found for the company and generates a tensor with the embeddings for the elaborated risk description tied to the risk associated with a given search result. These tensors for the headlines are referred to as result embedding data and those tensors (or “embedding tensors”) for the risk descriptions is referred to as risk description embedding data. Then, spam articles/content may be filtered out using a headline relevancy model transformer neural network (general model). Then, a second pass of the headline relevancy model transformer neural network is used to score each article from 1-5 based on how relevant the article is. In this second pass, an expert learner is used, which (in the present embodiment) is another instance of the headline relevancy model network (using the same architecture of the first model) that is fine-tuned specifically on supervised training examples for the sector a company is in (e.g. technology, basic materials, communication services, etc.). This enables the model to give a more realistic score for articles because there is more specificity in the kinds of examples it is trained on. The resulting scores of the articles or content are referred to as content relevancy scores and these content relevancy scores may be boosted if the headline includes the company name directly or specific keywords for a given risk category. Further, in embodiments, articles or other content that are duplicated, score less than a predetermined relevancy score, or that are blacklisted websites/publishers may be filtered out. Article or content metadata, such as the publication date, may be fetched and articles may be filtered based on date, such as filtering out articles that are X or more days old, for example. The list of articles or content (as filtered) may be stored in memory. The method 900 continues to step 950.

In step 950, the relevancy scores of the and, in embodiments, in a vector database. In embodiments, this step is carried out by the relevancy determination subsystem 122, and may include determining the top N highest scoring articles/content based on its associated content relevancy score that have been published in the last day (or other predefined time period), where Nis an integer such as 120 that may be predetermined; in another embodiment, the articles may be selected using different or additional criteria, such as semantic similarity between the risk description and the headline of the article. The semantic similarity is determined by a vector distance between the embedding tensors as defined in the previous paragraph. The embeddings of the headlines may be stored into a data store, such as a vector database. Then, the risk descriptions for each risk faced by the company may be queried, and the top M number of impactful headlines to the company based on the risks are determined through use of an LLM. Here, M is an integer, such as 3, that may be predetermined. Data for the top M articles (or “selected article data”) is then obtained, and this data may be the contents of the article, such as the article as a whole. The method 900 continues to step 960.

In step 960, a LLM is used to create a summary of how each of the selected articles impacts the financial entity based on the identified risks. In embodiments, the content summarizer subsystem 124 is used to perform this step. According to embodiments, the selected article data for the top article results is then input into an LLM for purposes of creating a summary around how each of the articles impacts the company based on the risks faced by the company. The list of articles and summaries therefor may be stored in memory. The method 900 then ends.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. An automated large language model (LLM) based risk summarization system, comprising:
a risk identification subsystem configured to extract information of an entity and to identify one or more risks faced by the entity based on the extracted information;
a risk validation subsystem configured to generate augmented risk data based on analyzing the one or more identified risks with trusted source document information obtained from one or more trusted source documents;
a search query generator subsystem configured to formulate one or more search queries based on the one or more identified risks and the augmented risk data;
a content finder subsystem configured to execute the one or more search queries to obtain search results having content indicator data; and
a content summarizer subsystem configured to use the LLM or another LLM to generate summary data that provides a summary of content associated with the content indicator data.

2. The system of claim 1, where the risk identification module utilizes a knowledge store, such as a database of structured information or a Large Language Model (LLM) to obtain information about the financial entity.

3. The system of claim 1, wherein the risk validation module uses a pre-trained version of Bidirectional and AutoRegressive Transformer (BART) to categorize chunks of text from trusted source documents into appropriate risk categories.

4. The system of claim 1, wherein the risk validation module uses an LLM to validate, augment, and summarize risk descriptions.

5. The system of claim 1, wherein the search query generator creates a graph of query templates based on predefined templates for each risk category.

6. The system of claim 1, wherein the news finder generates tensors with the embeddings for all the headlines found for a given financial entity, and a tensor with the embeddings for the elaborated risk description tied to the risk associated with a given article.

7. The system of claim 1, wherein the relevancy determination module uses an LLM to determine the top three most impactful headlines to the financial entity based on the risks faced by the entity.

8. The system of claim 1, wherein the article summarizer uses an LLM to create a summary around how each of the articles impacts the financial entity based on the risks faced by the entity.

9. The system of claim 1, wherein the system further comprises a mechanism for synthesizing company-level summaries or insights based on either the company's long-term history or immediate events influencing the near-term.

10. The system of claim 1, wherein the news finder further applies a Headline Relevancy Model Transformer Neural Network to filter out spam articles and score the relevance of each article.

11. The system of claim 10, wherein the Headline Relevancy Model Transformer Neural Network boosts the score if the headline includes the company name directly or specific keywords for a given risk category.

12. The system of claim 1, wherein the news finder filters out articles that are duplicated, score less than the minimum relevancy score, or are from blacklisted websites/publishers, or are published before a certain number of days.

13. The system of claim 1, wherein the content finder subsystem is configured to select the one or more search queries for execution based on a predefined threshold for query relevancy score generated based on relevancy of a given search query to the augmented risk data.

14. The system of claim 1, wherein the content finder subsystem is configured to generate content relevancy scores for resulting content based on each's relevance to the one or more identified risks.

15. The system of claim 1, further comprising a relevancy determination subsystem configured to select content to obtain based on the content relevancy scores, to obtain the content, and to store the content in a vector database.

16. The system of claim 1, wherein the summary data indicates, for a given article describing one or more events, impacts that are forecasted for the entity based on the identified risks and the one or more events.

17. An automated large language model (LLM) information extraction and summarization system, comprising:
a latent information extraction subsystem configured to extract latent information of an entity through querying an LLM for latent knowledge related to the entity;
a document information extraction subsystem configured to obtain document information related to the entity from one or more documents;
a search query generator subsystem configured to determine one or more search queries based on the latent information and the document information;
a content finder subsystem configured to execute the one or more search queries to obtain search results having content indicator data; and
a content summarizer subsystem configured to use the LLM or another LLM to create a summary of content associated with the content indicator data.

18. The system of claim 17, wherein the latent information and the document information pertain to one or more risks associated with the entity, and wherein the summary of the content is generated based on the one or more risks.

19. The system of claim 17, wherein the content indicator data of the search results includes headlines of one or more articles, and wherein the content associated with the content indicator data includes a body for each of the one or more articles.

20. The system of claim 17, wherein the content finder subsystem is configured to generate relevancy scores for the content indicator data relative to a relevancy target, and wherein the relevancy scores are used to select content associated with the content indicator data.

21. A method of retrieving and summarizing content based on risks for an entity, comprising the steps of:
extracting latent information of an entity through querying a large language model (LLM) for latent knowledge related to the entity;
obtaining document information related to the entity from one or more documents;
determining one or more search queries based on the latent information and the document information;
executing the one or more search queries to obtain search results having content indicator data; and
using the LLM or another LLM to create a summary of content associated with the content indicator data.
